(19) United States
(12) Patent Application Publication
(10) Pub. No.: US 2010/0052772 A1
(43) Pub. Date: Mar. 4, 2010

(54) Charge-Recycle Scheme for Charge Pumps

(76) Inventor: Caleb Yu-Sheng Cho, Zhubei City (TW)

Correspondence Address: SLATER & MATSIL, L.L.P., 17950 PRESTON ROAD, SUITE 1000, DALLAS, TX, 75252, US

(21) Appl. No.: 12/342,791

(22) Filed: Dec. 23, 2008

Related U.S. Application Data
(60) Provisional application No. 61/093,132, filed on Aug. 29, 2008.

(51) Int. Cl. G05F 3/02

(52) U.S. Cl. 327/536

(57) ABSTRACT

A method of operating a circuit includes providing a charge pump comprising an input and an output; charge-pumping an output voltage at the output of the charge pump to a high voltage; and discharging the output of the charge pump to power supply voltage VDD.

This application claims the benefit of U.S. Provisional Application No. 61/093,132 filed on Aug. 29, 2008, entitled “Charge-Recycle Scheme for Charge Pumps,” which application is hereby incorporated herein by reference.

### TECHNICAL FIELD

This invention relates generally to integrated circuits, and more particularly to flash memory circuits, and even more particularly to the preparation of drivers of flash memory circuits for operations.

### BACKGROUND

Flash memories have become increasingly popular in recent years. A typical flash memory comprises a memory array having a large number of memory cells arranged in blocks. Each of the memory cells is fabricated as a field-effect transistor having a control gate and a floating gate. The floating gate is capable of holding charges and is separated from source and drain regions contained in a substrate by a layer of thin oxide. Each of the memory cells can be electrically charged by injecting electrons from the substrate through the oxide layer onto the floating gate. The charges can be removed from the floating gate by tunneling the electrons to the source region or an erase gate during an erase operation. The data in flash memory cells are thus determined by the presence or absence of charges in the floating gates.

A common issue of flash memory circuits (and all memory circuits) is the speed of operations. For example, after a program operation, a flash memory circuit needs to be prepared for a read operation. This requires the drivers of the flash memory circuits to be charged or discharged to different voltages than for the program operation. The charging/discharging operations take time to finish, and some of the charging/discharging operations have become the bottleneck for improving the speed of the flash memory circuits. For example, the program operations need high voltages, sometimes 10 volts or even higher for source lines, while read operations need these HV modes discharged to certain lower levels (for example, VDD). The discharging from the high voltages to low voltages takes a relatively long time, since it is not desirable to discharge too rapidly. Otherwise, other circuits may be adversely affected by the cross talk. Therefore, after a program operation, the time needed for the discharging becomes the bottleneck in the operation of the flash memory circuits, and needs to be improved.

### SUMMARY OF THE INVENTION

In accordance with one aspect of the present invention, a method of operating a circuit includes providing a charge pump including an input and an output; charge-pumping an output voltage at the output of the charge pump to a high voltage; and discharging the output of the charge pump to power supply voltage VDD.

In accordance with another aspect of the present invention, a method of operating a circuit includes providing a charge pump including an input and an output; providing a switch connected between the output and a VDD node having a power supply voltage VDD; during a program stage of a memory, charge-pumping an output voltage at the output to a first high voltage; after the program stage of the memory, discharging the first high voltage to a second high voltage, wherein the second high voltage is between the first high voltage and the power supply voltage VDD; and after the step of discharging the first high voltage to the second high voltage, turning on the switch to connect the output of the charge pump to the VDD node.

In accordance with yet another aspect of the present invention, a circuit includes a charge pump including an input and an output; a VDD node having a power supply voltage VDD; and a switch connecting the output of the charge pump to the VDD node.

In accordance with yet another aspect of the present invention, a circuit includes a charge pump including an input and an output; a VDD node having a power supply voltage VDD, wherein the input of the charge pump is coupled to the VDD node; and a switch connected between the output of the charge pump and the VDD node. The switch is configured to disconnect the output of the charge pump from the VDD node during a first period of time the charge pump pumps up a voltage at the output, and interconnect the output of the charge pump to the VDD node during a second period of time after the first period of time.

The advantageous features of the present invention include reduced battery usage and a shortened back-to-standby stage for read operations immediately after a program operation.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a charge pump circuit having an output capable of being discharged to VSS;

FIG. 2 illustrates a sequence diagram of the circuit shown in FIG. 1;

FIG. 3 illustrates a charge pump circuit capable of recycling charges to a VDD node;

FIG. 4 illustrates a sequence diagram of the circuit shown in FIG. 3;

FIG. 5 illustrates a circuit with a plurality of drivers receiving recycled charges from the VDD node; and

FIG. 6 illustrates currents drawn from the VDD node as a function of time, wherein the VDD currents of the circuits shown in FIGS. 1 and 3 are compared.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

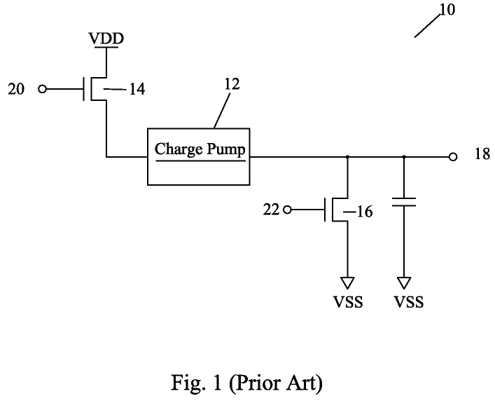

A conventional charge pump circuit for providing high voltages for flash memory circuits is shown in FIG. 1. Charge pump circuit 10 includes charge pump 12 supplied by operation voltage VDD, which is also referred to as a power supply voltage VDD. Transistor 14 is connected between operation voltage VDD and charge pump 12. Output node 18 of charge pump 12 is coupled to, so that it may be discharged to, power supply voltage VSS through transistor 16.

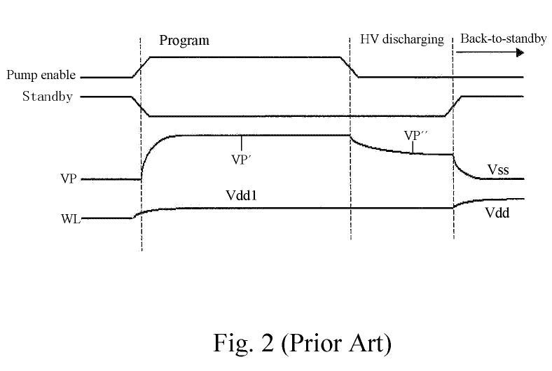

FIG. 2 illustrates a sequence diagram of the circuit shown in FIG. 1. It is noted that some of the signals (nodes) shown in FIG. 2 are related to the operation of charge pump circuit 10, but may not be shown in FIG. 1. The time sequence includes a program stage, a high voltage (HV) discharging stage, and a back-to-standby stage. In the program stage, node 20 (refer to FIG. 1), which carries a charge pump enable signal, is high to turn on transistor 14, and hence charge pump 12 receives operation voltage VDD through transistor 14. After certain cycles of charge pumping and sharing, the voltage VP at output node 18 (FIG. 1) of charge pump 12 is pumped to a high voltage VP′, as shown in FIG. 2. Voltage VP′ may be used to charge source line drivers (not shown), so that the source line drivers may perform program operations on flash memory cells. During the program stage, node 22 (FIG. 1) has a low voltage, so that transistor 16 is turned off.

After the program stage, charge pump circuit 10 needs to go into standby mode. Accordingly, the high voltage on node 18 needs to be lowered. This is accomplished by discharging node 18. Typically, the discharging includes two phases. The first phase is the HV discharging phase, in which node 18 is discharged to an intermediate high voltage VP″. The first phase is typically kept long to ensure the disturbance to other circuits is minimized. The second phase is also referred to as a back-to-standby stage, during which node 18 is discharged from the intermediate high voltage VP″ to voltage VSS. Accordingly, node 22 (refer to FIG. 1) becomes high to turn on transistor 16, and hence node 18 is discharged to VSS, which may be the ground (at 0V). During the discharging of node 18, transistor 14 is turned off by applying a low voltage to node 20, so that during the back-to-standby stage, no current (which current, if existing, would be a leakage current) flows directly from operation voltage node VDD to node VSS.

It is realized by the inventors of the present invention that in the operation discussed in the preceding paragraphs, the charges stored in node 18 and the capacitors in charge pump 12 are lost to VSS, which may be the ground. Due to the fact that the capacitors in charge pump 12 have relatively great capacitance, and the fact that the above-discussed operations need to be performed repeatedly, a considerable amount of charges are wasted during the above-discussed back-to-standby stage. This adversely causes an increase in power consumption. In the case the power is supplied by a battery, the interval between chargings of the battery will be reduced. Embodiments of the present invention are thus provided to solve the above-discussed problems.

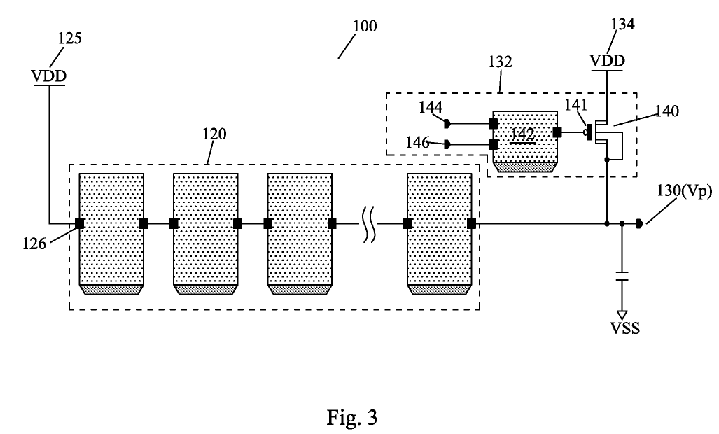

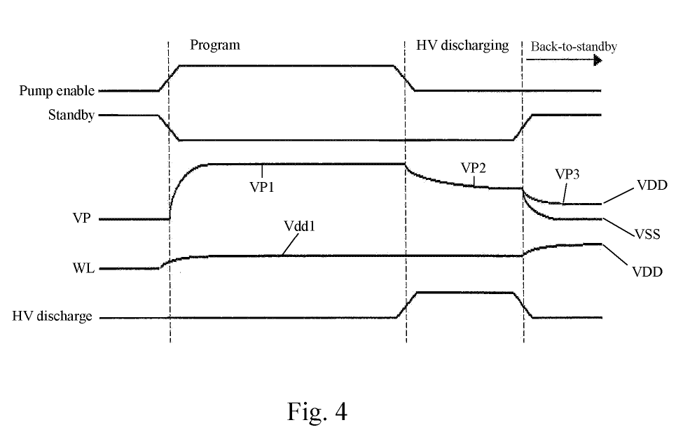

FIG. 3 illustrates an embodiment of the present invention, which includes charge pump circuit 100. Charge pump circuit 100 includes charge pump 120 and respective power supply and discharging circuit. Charge pump 120 may be any charge pump capable of outputting an appropriate output voltage VP1 (refer to FIG. 4) higher than the power supply voltage (operation voltage) VDD. In an embodiment, charge pump 120 is a four-phase charge pump, although it may also be any kind of charge pump circuit with any number of phases, and can pump the output voltage VP to, for example, about 11 volts. In an embodiment, power supply node 125 (with power supply voltage VDD) is directly connected to the input node 126 of charge pump 120 with no switches connected therebetween. In alternative embodiments of the present invention, a switch (for example, a transistor, not shown) may be connected between power supply node 125 and input node 126 of charge pump 120. Similar to what is shown in FIG. 1, the switch may be controlled by the charge pump enable signal.

Preferably, there is no direct DC-current path between output node 130 of charge pump 120 and VSS node, wherein the VSS node may be the ground. Instead, recycle-control circuit 132 is coupled between output node 130 and power supply node 134, which carries power supply voltage VDD. Power supply nodes 125 and 134 may be interconnected. Recycle-control circuit 132 is configured to turn off the path between output node 130 and power supply node 134 when charge pump 120 needs to be charged to a high voltage in program mode, and to turn on the path when output node 130 needs to be discharged when preparing for standby/read mode.

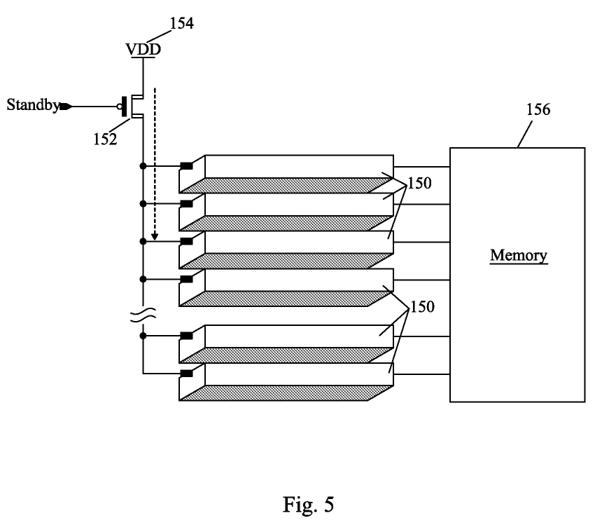

FIG. 4 illustrates an exemplary sequence diagram of the embodiment shown in FIG. 3. In the following discussion, the operation of charge pump circuit 100 as shown in FIG. 3 is discussed with reference to both FIGS. 3 and 4. Therefore, the reference numerals referred to in the following discussion are either in FIG. 3 or FIG. 4, and may not be specified individually. The sequence diagram illustrates three phases: a program phase, an HV discharging phase, and a back-to-standby (sometimes also referred to as a standby preparation stage) phase. After the back-to-standby phase, the memory is ready to be read at any time. In the program phase, the “Pump Enable” signal (FIG. 4) is turned on to start charge pump 120 in order to generate a high voltage. Meanwhile, the “standby” signal (FIG. 4) is low in order to turn off transistor 140 in recycle-control circuit 132, wherein the “standby” signal is provided to node 144. Accordingly, the output voltage VP at output node 130 (FIG. 3) is pumped to a high voltage VP1 (FIG. 4), for example, greater than about 10 volts. During the program phase, the voltage on word lines WL is preferably at a voltage Vdd1 (refer to FIG. 4) lower than power supply voltage VDD. Instead of VDD, the lower-VDD voltage “Vdd1” may be provided by a global voltage supply for all word line drivers (refer to FIG. 5). In the program phase, a selected word line receives Vdd1 from the global signal, while other word lines are kept at voltage VSS (which might be the ground). By coordinating high voltage VP in the source line and Vdd1 in the selected word line, the flash memory 156 (refer to FIG. 5) may be programmed. During the program phase, a signal named “HV discharging” is at a low voltage.

After the program phase, charge pump circuit 100 (FIG. 3) and the respective memory 156 (refer to FIG. 5) need to go into standby mode. Accordingly, the high voltage VP1 on node 130 needs to be lowered. This is accomplished by discharging output node 130. Again, the discharging may include two phases. During the first phase, the “HV discharging” signal (FIG. 4) goes to high, and hence an additional circuit (not shown) connected to output node 130 is activated to discharge the voltage on node 130 from voltage VP1 to voltage VP2, which is an intermediate voltage between voltage VP1 and power supply voltage VDD.

In the second phase, which is also referred to as a back-to-standby phase, the voltage VP on node 130 is discharged from voltage VP2 to power supply voltage VDD. The discharging is performed through recycle-control circuit 132, for example, by turning on transistor 140. Since node 132 has a voltage VP2 greater than the power supply voltage VDD at power supply node 134, charges are stored, and hence recycled, by power supply node 134. During the back-to-standby stage, the global power supply Vdd1 of all word line drivers is charged up to voltage level VDD. The recycled charge flowing from charge pump 120 into node 134 is provided to VDD preparation of all word line drivers. This is different from the conventional case, in which charges stored on the output node of the charge pump and inside the capacitors are discharged to node VSS (or the ground), and are wasted, although the charges are needed for word line drivers at the same time by VDD. Also, as is known in the art, power supply node 134 includes a plurality of metal lines, and has a relatively high capacitance for storing charges. The stored charges may be reused in subsequent operations requiring the power supply.

Referring again to FIG. 4, it is noted that during the back-to-standby stage, the voltage VP on node 130 is lowered to VDD, instead of VSS. Advantageously, this voltage is the same as the voltage at the input node 126 (FIG. 3) of charge pump 120. Therefore, there is no standby leakage current even if power supply node 125 in FIG. 3 is directly connected to the input node 126 of charge pump 120, and there is no need to have a switch between nodes 125 and 126. Accordingly, without the resistance of the transistor, a greater current may be provided by power supply node 125 to charge pump 120 during the charge pumping stage.

FIG. 5 illustrates an exemplary embodiment for using the recycled charges stored in power supply node 134. FIG. 5 includes a plurality of drivers 150. In an embodiment, drivers 150 are word line drivers that are used for driving the word lines. Referring to FIG. 4, at the program stage, the voltage on word lines WL is Vdd1, which is lower than power supply voltage VDD. However, for read operations, the voltages on word lines WL are preferably at power supply voltage VDD. Therefore, when entering the standby stage (controlled by the “standby” signal as shown in FIG. 4), word line drivers 150 need to be charged to power supply voltage VDD. The charging may be performed by turning on transistor 152, which is connected to VDD node 154. VDD node 154 may be connected to VDD node 134 as shown in FIG. 3. Therefore, when transistor 152 is turned on, the stored charges are used to charge drivers 150. In alternative embodiments, drivers 150 are source line drivers. It is noted that the charges stored in power supply node 134 are not limited to supplying drivers 150. Actually, any circuit connected to power supply node 134 may use the recycled charges. Accordingly, the consumption of battery power is reduced.

Recycle-control circuit 132 may have different implementations than shown in FIG. 3 as long as it can turn on the path between power supply node 134 and output node 130 when charges need to be recycled, and turn off the path when no recycling is to be performed. In an exemplary embodiment as shown in FIG. 3, gate 141 of transistor 140 is connected to a high voltage (HV) switch 142, which has input 144 connected to the “standby” signal (which is the same signal as shown in FIGS. 4 and 5) and input 146 connected to a high voltage signal having an amplitude no lower than voltage VP1 (refer to FIG. 4). When the “standby” signal at input 144 is high, a low voltage is output by HV switch 142, and hence transistor 140 is turned on so that charges on node 130 are recycled to power supply node 134. When the “standby” signal at input 144 is low, the high voltage inputted from input 146 is regulated and outputted by HV switch 142. Accordingly, the gate voltage (at node 141) of transistor 140 is no lower than the drain voltage of transistor 140, and hence transistor 140 is turned off.

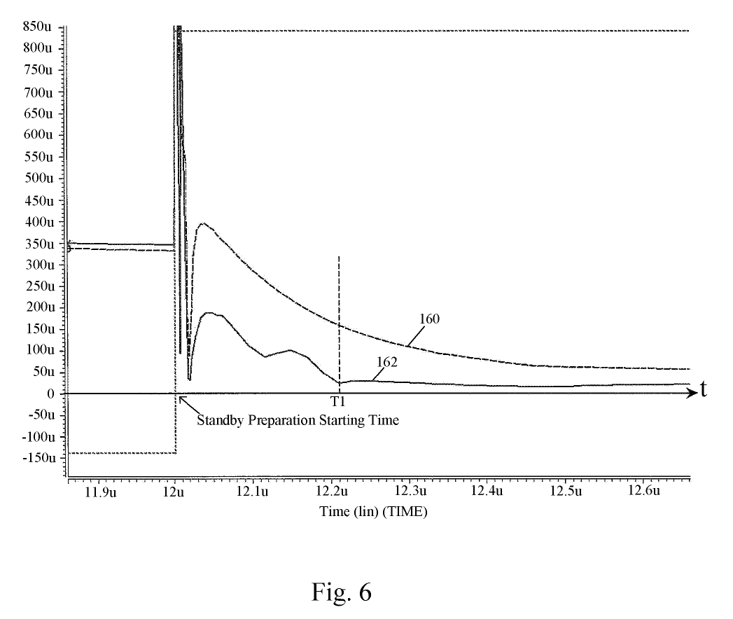

FIG. 6 illustrates simulation results, with currents drawing from power supply node 134 shown as a function of time. The Y-axis indicates the currents drawn from power supply nodes (such as power supply nodes 125 and 134 as shown in FIG. 3 or the “VDD” node as shown in FIG. 1), and the X-axis indicates the time t. Line 160 is obtained from the circuit shown in FIG. 1, while line 162 is obtained from the circuit shown in FIG. 3. It is observed that the current indicated by line 160 is significantly greater than the current indicated by line 162. Since the multiplication of current and time indicates the charge amount, line 162, with lower current, means a lower amount of charges drawn from power supply node 134, and hence less consumption of battery power. This is partially caused by the recycle of the charges. Simulation results also revealed that about 55 percent of charges stored in charge pump 120 may be recycled in the back-to-standby stage.

Further, it is noted at time T1, the current indicated by line 162 is only about 30 μA, indicating the preparation for standby is substantially finished. As a comparison, at time T1, line 160 still represents greater than about 150 μA current, and the high current continues for a much longer time. This indicates the embodiments of the present invention may achieve much quicker standby preparation than the circuit shown in FIG. 1.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of operating a circuit, the method comprising:
providing a charge pump comprising an input and an output;
charge-pumping an output voltage at the output of the charge pump to a high voltage; and
discharging the output of the charge pump to power supply voltage VDD.

2. The method of claim 1 further comprising:
before the step of discharging the output of the charge pump to the power supply voltage VDD, discharging the output of the charge pump to an intermediate voltage lower than the high voltage and higher than the power supply voltage VDD.

3. The method of claim 1, wherein the step of charge-pumping is performed during a program stage of a flash memory with the high voltage used to program the flash memory, and wherein the step of discharging the output is performed during a standby preparation stage for a read operation of the flash memory.

4. The method of claim 3, wherein, during a duration from a start time of the program stage to an end time of the standby preparation stage, no DC-current path connects the output of the charge pump to a ground.

5. The method of claim 1 further comprising:
providing a VDD node having the power supply voltage VDD; and
providing a switch connected between the output of the charge pump and the VDD node, wherein the step of discharging the output comprises turning on the switch to connect the output of the charge pump and the VDD node.

6. The method of claim 1, wherein the input of the charge pump is connected directly to a node having the power supply voltage VDD, with no switch therebetween.

7. The method of claim 1 further comprising charging word line drivers through a VDD node.

8. A method of operating a circuit, the method comprising:
providing a charge pump comprising an input and an output;
providing a switch connected between the output and a VDD node having a power supply voltage VDD;
during a program stage of a memory, charge-pumping an output voltage at the output to a first high voltage;
after the program stage of the memory, discharging the first high voltage to a second high voltage, wherein the second high voltage is between the first high voltage and the power supply voltage VDD; and
after the step of discharging the first high voltage to the second high voltage, turning on the switch to connect the output of the charge pump to the VDD node.

9. The method of claim 8, wherein during an entire duration between a start time of the program stage to a time the switch is turned on, no DC-current path exists between the output of the charge pump and any VSS node.

10. The method of claim 8, wherein the input of the charge pump is connected directly to the node having the power supply voltage VDD, with no switch therebetween.

11. The method of claim 8 further comprising charging word line drivers using the VDD node.

12. A circuit comprising:
a charge pump comprising an input and an output;
a VDD node having a power supply voltage VDD; and
a switch connecting the output of the charge pump to the VDD node.

13. The circuit of claim 12, wherein the switch is configured to disconnect the output of the charge pump from the VDD node during a first period of time the charge pump pumps up a voltage at the output, and to connect the output of the charge pump to the VDD node during a second period of time.

14. The circuit of claim 13, wherein the switch is configured to connect the output of the charge pump to the VDD node after the voltage at the output is pre-discharged.

15. The circuit of claim 12, wherein no switch exists between the output of the charge pump and any VSS node having a VSS voltage.

16. The circuit of claim 12, wherein the input of the charge pump is connected directly to the node having the power supply voltage VDD, with no switch therebetween.

17. A circuit comprising:
a charge pump comprising an input and an output;
a VDD node having a power supply voltage VDD, wherein the input of the charge pump is coupled to the VDD node; and
a switch connected between the output of the charge pump and the VDD node, wherein the switch is configured to disconnect the output of the charge pump from the VDD node during a first period of time the charge pump pumps up a voltage at the output, and to interconnect the output of the charge pump to the VDD node during a second period of time after the first period of time.

18. The circuit of claim 17, wherein the switch is configured to interconnect the output of the charge pump to the VDD node after the voltage at the output of the charge pump is pre-discharged to an intermediate voltage higher than the power supply voltage VDD.

19. The circuit of claim 17, wherein no switch exists between the output of the charge pump and any VSS node having a VSS voltage.

20. The circuit of claim 17, wherein the input of the charge pump is connected directly to the VDD node, with no switch therebetween.
